(19) United States
(12) Patent Application Publication
(10) Pub. No.: US 2009/0123837 A1
(43) Pub. Date: May 14, 2009

(54) Lithium rechargeable electrochemical cell

(76) Inventors: Michael Gratzel, St-Sulpice (CH); Ivan Exnar, Itingen (CH); Qing Wang, Ecublens (CH)

Correspondence Address: NIXON & VANDERHYE, PC, 901 NORTH GLEBE ROAD, 11TH FLOOR, ARLINGTON, VA, 22203, US

(21) Appl. No.: 11/921,570

(22) PCT Filed: Jun. 2, 2006
(86) PCT No.: PCT/IB2006/051781

§ 371 Date: Dec. 5, 2007

(30) Foreign Application Priority Data
Jun. 6, 2005 (EP) 05104908.9

(51) Int. Cl. H01M 4/02; H01M 4/62; B05D 5/12

(52) U.S. Cl. 429/209; 427/115

(57) ABSTRACT

This invention concerns a lithium rechargeable electrochemical cell comprising an electrochemically addressable electrode system. The electrodes are composed of a cathodic lithium insertion material (2) incorporating a p-type conductive compound (4), and an anodic lithium insertion material (3) incorporating an n-type conductive compound (5). Such a rechargeable electrochemical cell is suitable for high energy density applications. The present invention also concerns the general use of conductive compounds and electrochemically addressable electrode systems comprising similar components which are suitable for use in the electrochemical cell.

### FIELD OF THE INVENTION

This invention concerns electrochemically addressable lithium insertion electrodes for electrochemical cells using non-aqueous organic electrolytes, quasi-solid gel electrolytes, solid polymer electrolytes or the like and in particular the use of said electrolytes in combination with porous electrode materials, i.e. doped or non-doped nanoparticles or sub-microparticles of lithium insertion materials incorporating conductive compounds.

The conductive compound attaches to the surface of the lithium insertion material by chemisorption. Because it occupies a very small part of the volume of the whole electrode system, it provides excellent energy density of the electrochemical cell.

This invention also concerns the processes for obtaining electrochemically addressable electrode system.

### DESCRIPTION OF PRIOR ART

Electrochemical cells, as illustrated in FIG. 1, have used lithium insertion materials by adding conductive additive, i.e. carbon black, carbon fiber, graphite, or mixture of them to improve the electronic conductivity of the electrode films.

The lithium insertion materials in commercial electrochemical cells comprise 2˜25 wt. %, typically 10 wt. % conductive additives. These conductive agents do not participate in the redox reactions and therefore represent inert mass reducing the specific energy storage capacity of the electrode. This situation is especially severe as the lithium insertion material or its de-intercalated state has very poor electronic conductivity.

For instance, pioneering work by Padhi et al (J. Electrochem. Soc. 144, 1188 (1997).) first demonstrated reversible extraction of Li from the olivine-structured LiFePO₄, however 25 wt. % acetylene black was added. This is also illustrated in JP 2000-294238 A2 wherein a LiFePO₄/Acetylene Black ratio of 70/25 is used.

U.S. Pat. No. 6,235,182 and international patent application WO 92/19092 disclose a method for coating insulators with carbon particles by substrate-induced coagulation. This method involves the adsorption of polyelectrolyte compound and subsequent coagulation of carbon particle on the substrate to form an adhesive carbon coating. For high quality carbon coating, the size of carbon particle is very dependent on the dimension of substrate and the amount of carbon used is still remarkable.

International patent application WO 2004/001881 discloses a new route for the synthesis of carbon-coated powders having the olivine or NASICON structure by mixing the precursors of carbon and said materials and subsequent calcinations. Nevertheless, it is still necessary to have 4˜8 wt. % of coated carbon to exploit the invention fully. European patent application EP 1244168 and U.S. Pat. No. 6,870,657 discloses an electrochemical device, wherein a mesoscopic metal oxide film modified by chemisorption of an electroactive compound is included. The attached electroactive compounds undergo reversible redox reaction and show electrochromism at specific potentials. The substrates herein are just inert transparent support.

European patent application EP 1548862 discloses fullerene derivatives as SEI additives for carbonaceous (i.e. electronically conducting) anode material for a lithium secondary battery.

Japanese patent application JP 2002117830 is disclosing the semiconductor properties of different additives to improve the high temperature properties of lithium ion batteries. Although these additives can be redox compounds they don't allow an efficient charge propagation on the surface of the electrodes.

### SUMMARY OF THE INVENTION

It has been discovered that chemisorption of a layer of a conductive compound on the particles of lithium insertion material forms an electrochemically addressable electrode system. As illustrated in FIG. 2, for a combination of a cathodic lithium insertion material and p-type conductive compound, upon positive polarization charges (holes) will be transported from the current collector to the lithium insertion material through the conductive layer by cross-surface percolation. As the redox potential of the adsorbed compound matches closely the Fermi level of the lithium insertion material electrons and lithium ions will be withdrawn from it during battery charging. By contrast, during the discharging process lithium ions and electrons are injected into the solid.

The conductive species will adsorb onto the lithium insertion material powder or as-prepared electrode sheets comprising the same material by immersing or dipping it in a solution of the conductive compound. The thickness of the conductive layer is not more than 5 nm. Even a single molecular layer of a suitable redox active compound can provide the desired electronic charge transport while still permitting lithium ion exchange to occur rapidly across the solid/electrolyte interface. Compared to the whole electrode system, the space occupied by this charge transport layer is very small. Hence with respect to prior art, the present invention allows reducing greatly the volume of the conductive additives resulting in a much improved energy storage density.

It is therefore an object of the invention to provide a means to avoid or minimize the amount of the conductive additives required for the operation of an ion insertion battery. It is also an object of the invention to provide a rechargeable electrochemical cell having higher energy density.

The present invention is based on the recent discovery of cross surface electron and hole transfer in self-assembled molecular charge transport layers on mesoscopic oxide films.

A monolayer of redox-active molecules is chemisorbed on the surface of insulating nanocrystalline oxide particles. Upon positive polarization, the molecules attached to the current collector are first oxidized generating empty electronic states. Subsequently, electrons from adjacent molecules percolate to fill the empty states. Charge propagation within the surface confined monolayer proceeds by thermally activated electron hopping between adjacent molecules. At the same time, counter ions in the electrolyte diffuse to compensate the charge of the oxidized molecules. A macroscopic conduction pathway is formed once the coverage of the oxide nanoparticles by the electro-active species exceeds 50%.

### DEFINITIONS

As used herein, the term “lithium insertion material” refers to the material which can host and release lithium or other small ions such as Na⁺, Mg²⁺ reversibly. If the materials lose electrons upon charging, they are referred to as “cathodic lithium insertion material”. If the materials acquire electrons upon charging, they are referred to as “anodic lithium insertion material”.

As used herein, chemisorption is a phenomenon related to adsorption in which atoms or molecules of reacting substances are held to the surface atoms of a catalyst by electrostatic forces having about the same strength as chemical bonds. Adsorption in which a chemical reaction takes places only at the surface of the adsorbent.

It should be noted that chemisorption differs from physical adsorption chiefly in the strength of the bonding, which is much less in adsorption than in chemisorption. The surface at which chemisorption takes place is usually a metal or metal oxide; the chemisorbed molecules are always changed in the process, and often the molecules of the surface are changed as well. Hydrogen and hydrocarbons are readily chemisorbed on metal surfaces, the hydrocarbons being so modified that they yield active initiating groups (carbonium ions, etc.). Thus, chemisorption is an essential feature of catalytic reactions and accounts in large measure for the specialized activity of catalysts.

As used herein, the term “p-type conductive compound” refers to those compounds that are adsorbed on the surface of cathodic lithium insertion material, and are oxidized upon charging by lateral percolation of positive charges or “holes” through the adsorbed molecular charge transport layer. On the other hand, the term “n-type conductive compound” refers to a molecular charge transport layer adsorbed at the surface of anodic lithium insertion material, and which is reduced upon charging by lateral electron percolation through the thin adsorbed layer.

As used herein, the term “electrochemically addressable” refers to the behavior of an electrode system for which the interface is accessible to ions in electrolyte as well as to electrons or holes injected via cross surface charge transfer from the substrate current collector.

### BRIEF DESCRIPTION OF THE DRAWINGS

The features and advantages of the invention are further set out in the following examples, illustrated by way of a non-limiting example with reference to the appended drawings in which:

FIG. 1 shows a schematic sectional view of the prior art rechargeable electrochemical cell during discharging process.

FIG. 2 shows the schematic working principle of the electrochemically addressable electrode system. 1: back current collector; 2: cathodic lithium insertion material; 3: anodic lithium insertion material; 4: p-type conductive layer; 5: n-type conductive layer. (A) cathode; (B) anode.

FIG. 3A shows cyclic voltammograms of bare LiFePO₄ electrode in ethylene carbonate/dimethyl carbonate/1M LiPF₆ electrolyte. The counter and reference electrodes are lithium foils. The scan rate is 5 mV/s.

FIG. 3B shows cyclic voltammograms of 2-(10-phenothiazyl)ethylphosphonic acid attached LiFePO₄ electrode in ethylene carbonate/dimethyl carbonate/1M LiPF₆ electrolyte. The counter and reference electrodes are lithium foils. The scan rate is 5 mV/s.

FIG. 3C shows cyclic voltammograms of 3-(4-(N,N-dip-anisylamino)phenoxy)-propyl-1-phosphonic acid attached LiFePO₄ electrode in ethylene carbonate/dimethyl carbonate/1M LiPF₆ electrolyte. The counter and reference electrodes are lithium foils. The scan rate is 5 mV/s.

FIG. 4 shows the voltage profiles a 2-(10-phenothiazyl)ethylphosphonic acid attached LiFePO₄ electrode in ethylene carbonate: dimethyl carbonate/1M LiPF6 electrolyte. The current is 0.02 mA.

### DESCRIPTION OF ILLUSTRATIVE EMBODIMENTS

The following sections describe, in turn, the introduction of the concept, the relevant materials used in the electrode system, the process of electrode preparation, and embodiment in an electrochemical cell. These are followed by descriptions of examples of the electrode system and the resultant electrochemical cell.

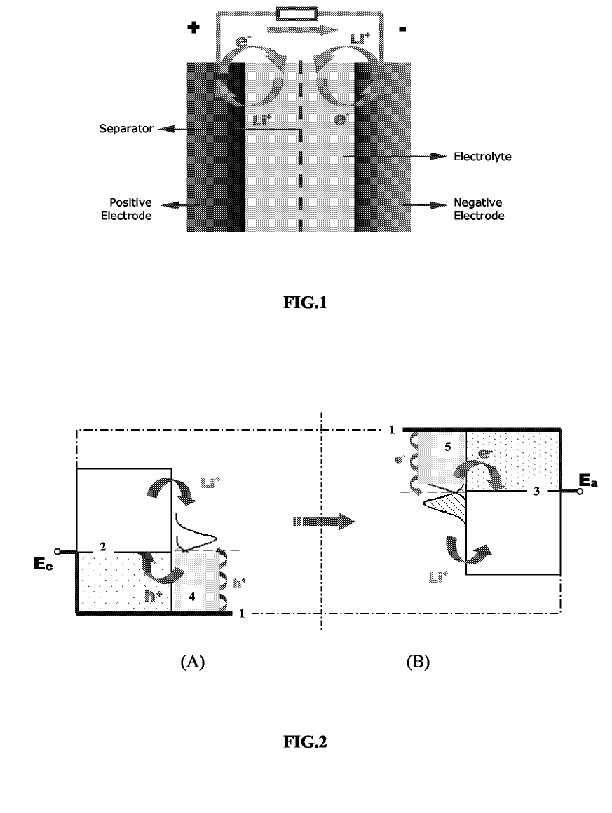

As illustrated in FIG. 2 (A), a p-type conductive compound is chemisorbed on the surface of nano- or sub-micrometer sized cathodic lithium insertion material. Upon charging the cell, the adsorbed conductive compound will be oxidized. Positive charges (hole) will flow along the surface by lateral percolation within the molecular charge transport layer adsorbed on the particles of the lithium insertion compound allowing for electrochemical polarization of the whole particle network by the current collector even though the lithium insertion material is electronically insulating and no carbon additive is used to promote conduction. If the redox potential of the conductive compound matches that of the lithium insertion compound, electronic charge (electrons or holed depending on the applied potential) are injected from the molecular film into the particles and this is coupled to lithium insertion or release. More specifically during the charging of the battery, electrons and lithium ions are withdrawn from the lithium insertion compound while during the discharge process they are reinserted into the same material. As illustrated in FIG. 2 (B), an analogous mechanism is operative during discharging or charging of a lithium insertion material functioning as anode the molecular charge transport layer conducting electrons in this case.

The relevant materials used in the cathodic electrode system comprise a cathodic lithium insertion material and a p-type conductive compound adsorbed thereto.

Preferred cathodic lithium insertion materials used herein are:

Doped or non-doped LiCoO₂, LiNiO₂, LiMnO₂, LiMn₂O₄, LiFePO₄, LiMnPO₄, LiCoPO₄ nano- or sub-microparticles. The particle size ranges from 5 nm to 10 micrometer, preferably 10˜500 nm.

Preferred p-type conductive compounds have the following structure:

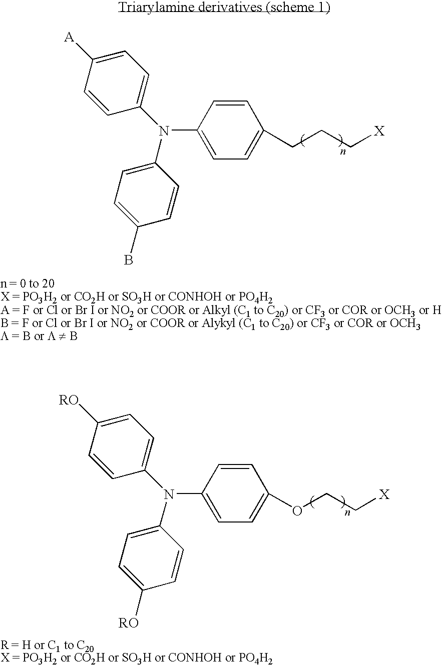

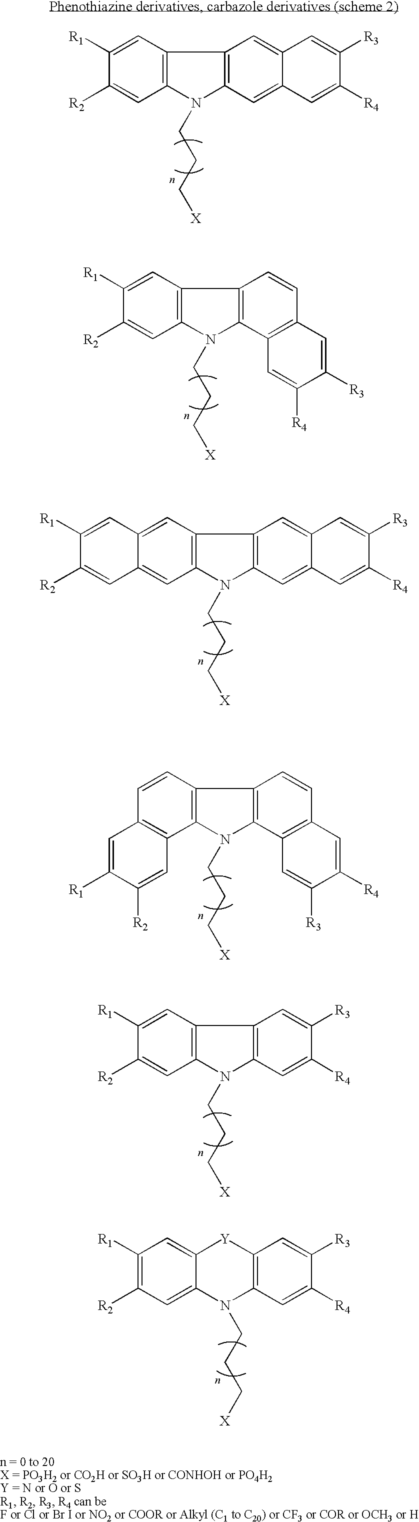

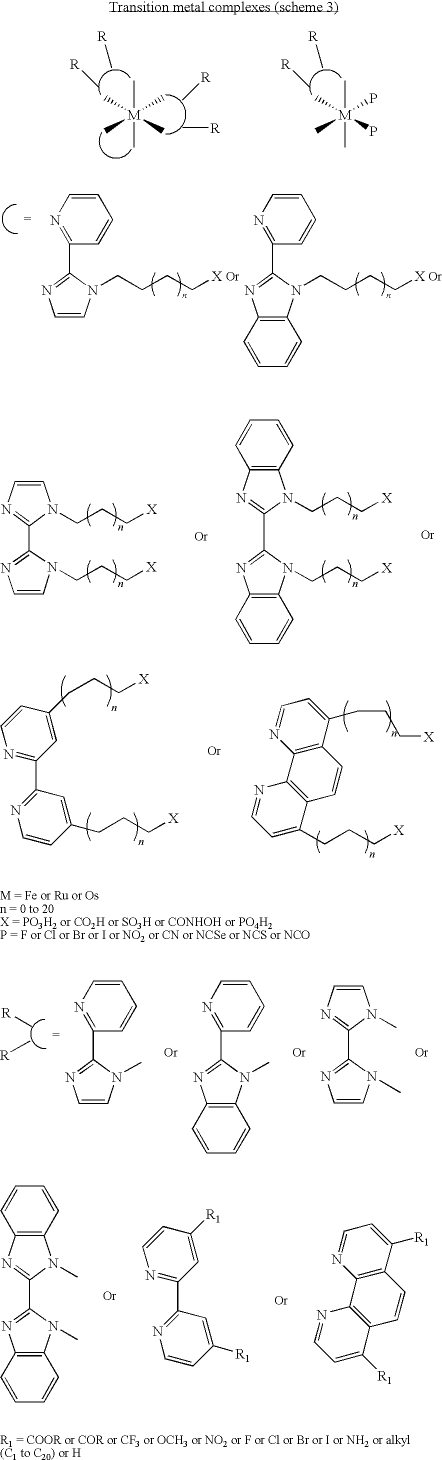

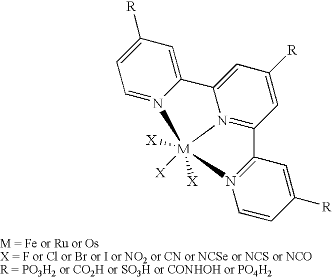

The relevant materials used in the anodic electrode system comprise an anodic lithium insertion material and an n-type conductive compound adsorbed thereto.

Preferred anodic lithium insertion materials used herein are:

Doped or non-doped TiO₂, SnO₂, SnO, Li₄Ti₅O₁₂ nano- or sub-microparticles. The particle size ranges from 10 nm to 10 micrometer, preferably 10˜500 nm.

Preferred n-type conductive compounds have the following structure:

Transition metal complexes (see above, scheme 3),

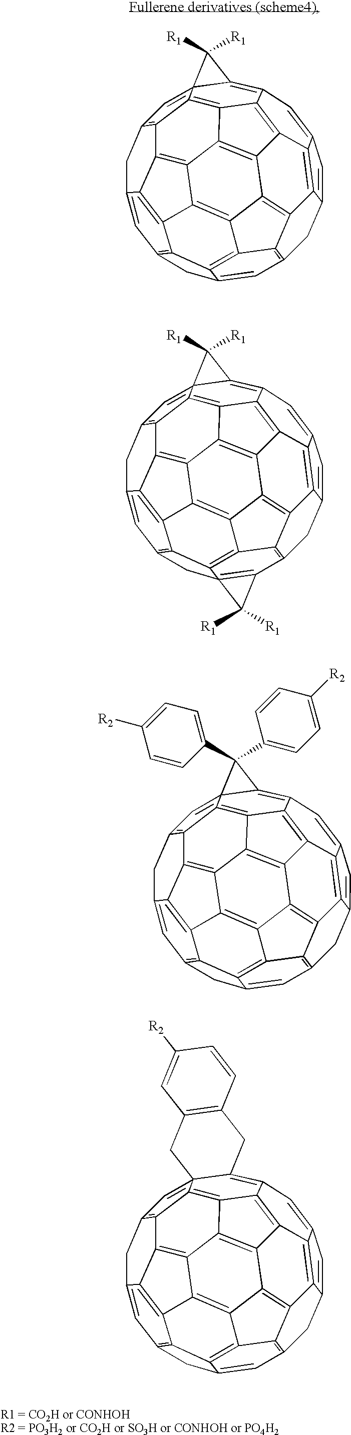

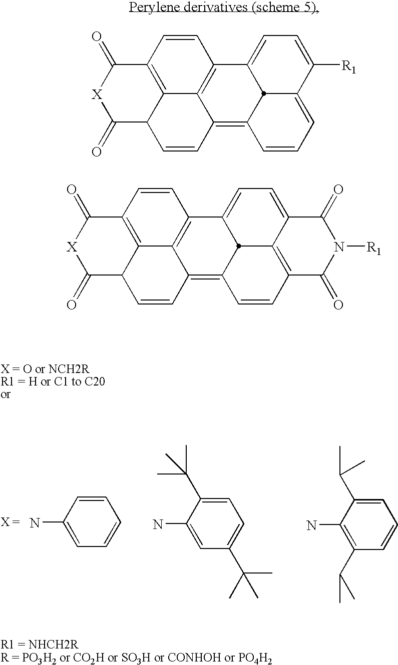

The invention includes two kinds of electrode formation processes:
(a) Dip electrode sheets comprising the lithium insertion material, 0˜15 wt. % of binder, and 0˜10 wt. % of conductive additives, such as carbon black, acetylene back, carbon fiber, graphite and mixture of them, into solution of the conductive compound for few hours. The treated electrode sheets are then washed with same solvent;
(b) Mix the powder of the lithium insertion material with solution of the conductive compound for few hours. The treated powder is then separated, washed, and used to prepare the electrode sheet. The final electrode comprises the cathodic lithium insertion material, 0˜15 wt. % of binder, and 0˜10 wt. % of conductive additives, such as carbon black, acetylene back, carbon fiber, graphite, and mixture of them.

In one embodiment of the invention, the rechargeable electrochemical cell comprises:
(a) A first electrode comprising binder, conductive additives, and cathodic lithium insertion material with or without p-type conductive compound adsorbed thereto;
(b) A second counter electrode comprising binder, conductive additives, and anodic lithium insertion material with or without n-type conductive compound adsorbed thereto.
(c) At least one of the electrodes with conductive compound adsorbed thereto.
(d) An electrolyte intermediate the electrodes.

In a preferred embodiment, the rechargeable electrochemical cell according to the invention comprises:
(a) A first electrode comprising binder, and cathodic lithium insertion material having p-type conductive compound adsorbed thereto;
(b) A second counter electrode comprising binder, conductive additives, and anodic lithium insertion material such as carbon, TiO₂, Li₄Ti₅O₁₂, SnO₂, SnO, SnSb alloy, Si, etc.
(c) An electrolyte intermediate the electrodes.

In a particularly preferred embodiment of the rechargeable electrochemical cell of the present invention, the first electrode comprising binder, conductive additives, and doped or non-doped LiMPO₄, wherein M=Fe, Mn, Co, having p-type conductive compound adsorbed thereto; and the second electrode comprising binder, conductive additives, and anodic lithium insertion material.

In this embodiment, the electronic conductivity of the cathodic lithium insertion materials is very poor, and the adsorbed conductive layer makes the treated electrode system much more electrochemically addressable; meanwhile during lithium insertion/extraction, their volume changes are very small, rendering the adsorbed conductive layer rather stable.

The invention is illustrated in the following EXAMPLES.

### EXAMPLE 1

LiFePO₄ powder with particle size distribution of 200˜700 nm was mixed with PVDF in weight ratio of 95:5. A 1.0 cm×1.0 cm electrode sheet comprising 10 μm thick same was then dipped into 2 mM solution of 2-(10-phenothiazyl)ethylphosphonic acid in acetonitrile for 2 hours.

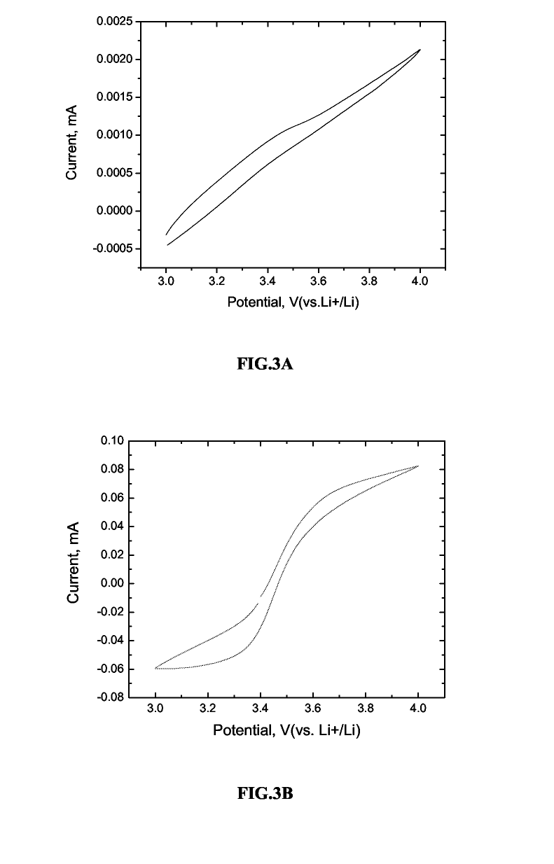

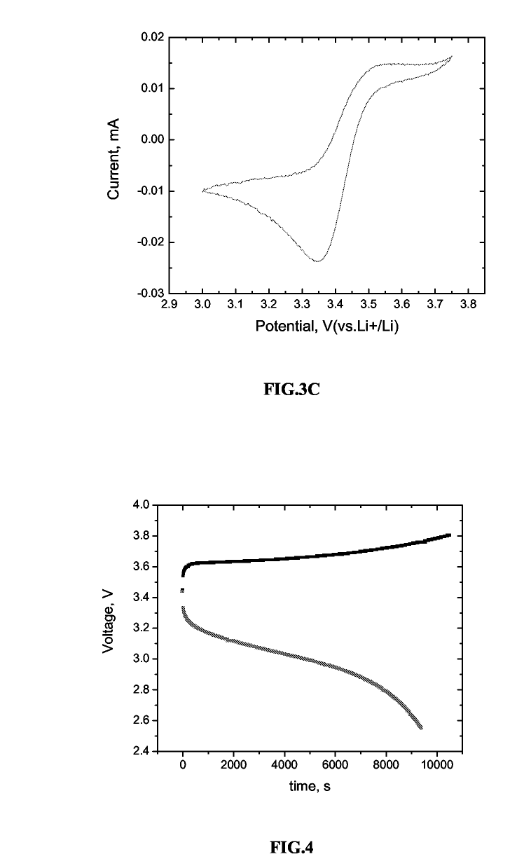

After washing, the treated electrode sheet was used as working electrode, with lithium foil as counter and reference electrodes for electrochemical test. FIG. 3B shows the cyclic voltammograms (CV) of the electrode system in EC+DMC (1:1)/1M LiPF₆ electrolyte. Because the charge injection is turned on at around 3.5V (vs. Li+/Li), the CV shows steady-state like curve. The limiting currents are 0.08 mA/cm² for charging and 0.06 mA/cm² for discharging, controlled by the percolation rate of charge through the conductive layer. FIG. 4 shows the voltage profiles of the electrode system at a constant current of 0.02 mA. In comparison, LiFePO₄ electrode sheet without p-type conductive compound adsorbed thereto is almost inactive as shown in FIG. 3A.

### EXAMPLE 2

LiFePO₄ powder with particle size distribution of 200˜700 nm was mixed with PVDF and acetylene black in weight ratio of 94:5:1. A 1.0 cm×1.0 cm electrode sheet comprising 10 μm thick same was dipped into 2 mM solution of 2-(10-phenothiazyl)ethylphosphonic acid in acetonitrile for 2 hours.

### EXAMPLE 3

LiFePO₄ powder with particle size distribution of 200˜700 nm was mixed with PVDF in weight ratio of 95:5. A 1.0 cm×1.0 cm electrode sheet comprising 10 μm thick same was dipped into 2 mM solution of 3-(4-(N,N-dip-anisylamino)phenoxy)-propyl-1-phosphonic acid in acetonitrile for 2 hours.

After washing, the treated electrode sheet was used as working electrode, with lithium foil as counter and reference electrodes for electrochemical test. FIG. 3C shows the cyclic voltammograms (CV) of the electrode system in EC+DMC (1:1)/1M LiPF₆ electrolyte. Because the charge injection is turned on at around 3.5V (vs. Li+/Li), the CV shows steady-state like curve.

1. A rechargeable electrochemical cell including at least one electrode comprising not electronically conducting cathodic or anodic lithium insertion material, characterized by the fact that said electrode furthermore comprises a conductive compound which forms a layer on said cathodic or anodic lithium insertion material by chemisorption, said conductive compound being a p- or n-type redox active compound, the redox potential of said conductive compound matching the Fermi level of said lithium insertion material.

2. The rechargeable electrochemical cell according to claim 1 wherein said layer is a single molecular layer with a thickness of no more than 5 nm.

3. The rechargeable electrochemical cell according to claim 1 comprising cathodic lithium insertion material selected from doped or non-doped oxides LiMO₂ where M is one or more elements selected from M=Co, Ni, Mn, Fe, W, V, LiV₃O₈; phosphor-olivines as LiMPO₄ where M is one or more elements selected from with M=Fe, Co, Mn, Ni, V, Cr, Cu, Ti and spinels and mixed spinels as LiₓMn₂O₄ or Li₂CoₓFe_{y}Mn_{z}O₈, etc.

4. The rechargeable electrochemical cell according to claim 1 comprising anodic lithium insertion material selected from carbon, TiO₂, Li₄Ti₅O₁₂, SnO₂, SnO, Si, etc.

5. The rechargeable electrochemical cell according to claim 1 wherein the particle size of the lithium insertion material ranges from 1 nm to 10 μm.

6. The rechargeable electrochemical cell according to claim 1 comprising:
(a) A first electrode containing a binder, conductive additives, and nano- or sub-micrometer sized cathodic lithium insertion material with or without p-type redox active compound chemisorbed thereto, the oxidation potential of the p-type redox active compound matching the Fermi level of the cathodic lithium insertion material,
(b) A second electrode containing a binder, conductive additives, and anodic lithium insertion material with or without n-type redox active compound chemisorbed thereto, the reduction potential of the n-type redox active compound matching the Fermi level of the anodic lithium insertion material,
(c) At least one of the above said electrode materials is chemisorbed with redox active compound,
(d) An electrolyte is presenting in between the above said electrodes.

7. A process for preparing a rechargeable electrochemical cell as defined in claim 1, said process comprising the following steps:
dipping the electrode sheet into a solution of redox active compound for a few hours, the electrode sheet comprises the lithium insertion material, a binder (0˜15 wt. %) and conductive additives (0-10 wt. %), such as carbon black, acetylene back, carbon fiber, graphite, and mixture of them,
washing the above surface modified electrode sheet with a solvent to remove any non-bonded redox active compound.

8. A process for preparing an rechargeable electrochemical cell as defined in claim 1, said process comprising the following steps:
mixing a powder of lithium insertion material with a solution of a redox active compound for a few hours,
separating and washing the above surface modified powder to remove any non-bonded redox active compound,
preparing an electrode sheet with the above surface modified powder, the said electrode sheet comprises a cathodic lithium insertion material, a binder (0-15 wt. %) and conductive additives (0-10 wt. %), such as carbon black, acetylene back, carbon fiber, graphite, and mixture of them.
